(19) United States
(12) Patent Application Publication
(10) Pub. No.: US 2019/0264702 A1
(43) Pub. Date: Aug. 29, 2019

(54) CEILING FAN INCLUDING MODULAR ACCESSORIES

(71) Applicant: TTI (MACAO COMMERCIAL OFFSHORE) LIMITED, Macau (MO)

(72) Inventors: Mark Huggins, Anderson, SC (US); Scott P. Kippes, Piedmont, SC (US); Alexandra E. Giles, Greenville, SC (US)

(21) Appl. No.: 16/286,137

(22) Filed: Feb. 26, 2019

Related U.S. Application Data
(60) Provisional application No. 62/636,188, filed on Feb. 28, 2018.

(51) Int. Cl. F04D 29/00; F04D 25/08; A01M 29/12; H01R 33/97; B01D 46/00

(52) U.S. Cl. CPC F04D 29/005; F04D 25/088; F04D 19/002; H01R 33/97; B01D 46/0038; A01M 29/12

(57) ABSTRACT

A ceiling fan may include a hub having a first end, a second end opposite the first end, a central axis extending through the first end and the second end, and an accessory interface disposed proximate to the first end or the second end. The ceiling fan may also include a subframe disposed proximate to the hub, the subframe being rotatable with respect to the hub about the central axis, a plurality of fan blades extending outwardly from the subframe, and an accessory unit, the accessory unit being removably coupled to the accessory interface of the hub.

### CROSS-REFERENCE TO RELATED APPLICATION

This application claims priority to U.S. Provisional Patent Application No. 62/636,188, filed Feb. 28, 2018, the entire contents of which are incorporated herein by reference.

### BACKGROUND

The present subject matter relates to ceiling fans and, more particularly, to accessories for use with ceiling fans.

Ceiling fans are fixtures that are coupled to and/or hung from a ceiling of a particular room for use in generating a cooling and/or ventilating airflow within the room.

### SUMMARY

In one embodiment, a ceiling fan may include a hub having a first end, a second end opposite the first end, a central axis extending through the first end and the second end, and an accessory interface disposed proximate to the first end or the second end. The ceiling fan may also include a subframe disposed proximate to the hub, the subframe being rotatable with respect to the hub about the central axis, a plurality of fan blades extending outwardly from the subframe, and an accessory unit, the accessory unit being removably coupled to the accessory interface of the hub.

In another embodiment, a fan may include a hub including an accessory interface having an electro-mechanical coupling mechanism, a subframe rotatable with respect to the hub, a plurality of fan blades extending outwardly from the subframe, a first accessory unit configured to removably couple to the accessory interface of the hub, and a second accessory unit configured to removably couple to the accessory interface of hub.

In another embodiment, a fan may include a hub having a first accessory interface, and a second accessory interface, a subframe rotatable with respect to the hub, a plurality of fan blades extending outwardly from the subframe, a first accessory unit physically and electrically coupled to the first accessory interface, the first accessory unit being configured to perform a first task, and a second accessory unit physically and electrically coupled to the second accessory interface, the second accessory unit being configured to perform a second task.

Other aspects of the subject matter will become apparent by consideration of the detailed description and accompanying drawings.

### BRIEF DESCRIPTION OF THE DRAWINGS

FIG. 1 illustrates a ceiling fan including an accessory unit.

FIG. 2 illustrates the ceiling fan where the accessory unit includes an area light.

FIG. 3 illustrates the ceiling fan where the accessory unit includes adjustable spot lights.

FIG. 4 illustrates the ceiling fan where the accessory unit includes a speaker.

FIG. 5 illustrates the ceiling fan where the accessory unit includes a scented air distributor.

FIG. 6 illustrates the ceiling fan where the accessory unit includes an air filter.

FIG. 7 illustrates the ceiling fan where the accessory unit includes a bug repellant diffuser.

FIG. 8 illustrates the ceiling fan where the accessory unit includes a security camera.

FIG. 9 illustrates the ceiling fan where the accessory unit includes an image diffuser.

FIG. 10 illustrates the ceiling fan where the accessory unit includes an air quality monitor.

FIG. 11 illustrates the ceiling fan where the accessory unit includes a heating unit.

FIG. 12 illustrates the ceiling fan where the accessory unit includes an uplighting unit.

FIG. 13 is a bottom perspective view of another embodiment of a ceiling fan.

FIG. 14 is a top perspective view of the ceiling fan of FIG. 13.

FIG. 15 is an enlarged perspective view of a portion of the ceiling fan of FIG. 13 with an accessory unit removed.

FIG. 16 is a front perspective view of an accessory unit for use with the ceiling fan of FIG. 13.

FIG. 17 is a rear perspective view of the accessory unit of FIG. 17.

FIG. 18 is an enlarged perspective view of the accessory unit attached to the ceiling fan of FIG. 13.

FIG. 19 is a bottom perspective view of another embodiment of the ceiling fan.

FIG. 20 is a bottom perspective view of the ceiling fan of FIG. 19 with accessory units exploded apart from the ceiling fan.

Before any embodiments of the subject matter is explained in detail, it is to be understood that the subject matter is not limited in its application to the details of construction and the arrangement of components set forth in the following description or illustrated in the following drawings. The subject matter is capable of other embodiments and of being practiced or of being carried out in various ways. In instances where multiple embodiments are present, same elements will be described with the same reference number, but with the addition of one or more prime indicators.

### DETAILED DESCRIPTION

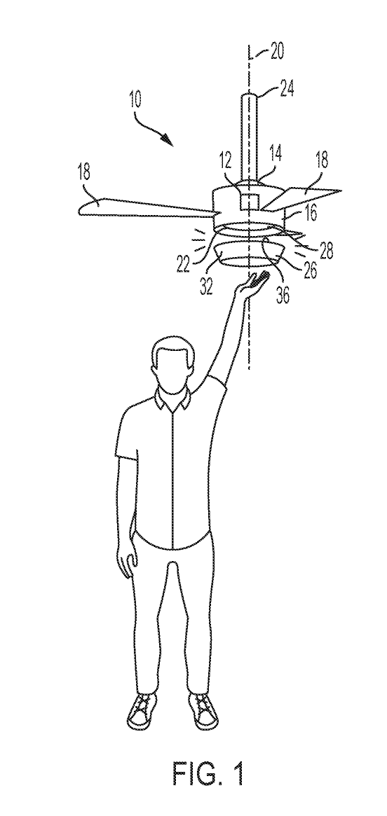

FIG. 1 illustrates a fan, generally designated 10. In the illustrated embodiment, the fan 10 is a ceiling fan that may be mounted to a ceiling or other overhead support structure. As such, the fan will be referred to as a ceiling fan throughout. In other embodiments, however, the fan may include other types of fans, such as pedestal fans, desktop fans, window fans, personal fans, and/or the like.

The ceiling fan 10 may include a hub 14 configured to fixedly couple to a ceiling (not shown) or other support surface (e.g., a beam, a frame, and/or the like), either directly or indirectly (e.g., by way of a downrod). The ceiling fan 10 may include a rotating body portion disposed on, over, around, adjacent to, and/or proximate to the hub 14, such as a subframe 16 rotatably coupled to the hub 14 for rotation with respect thereto about a first or central axis 20 of the hub 14. The ceiling fan 10 may include a plurality of fan blades 18 coupled to and extending radially outwardly from the subframe 16. The fan blades 18 may rotate with the subframe 16 relative to the hub 14 for generating an airflow as described herein.

The hub 14 may include a first end 24 (e.g., disposed proximate to the ceiling or attach surface) and a second end 28 opposite the first end 24. The central axis 20 may extend through the first end 24 and the second end 28. The second end 28 may be axially displaced from the first end 24 along the central axis 20. The hub 14 may support a motor 12 which is operably coupled to the subframe 16 and configured to rotate the fan blades 18 together with the subframe 16 relative to the hub 14 about (around) the central axis 20. In the illustrated embodiment, the hub 14 may be mounted to a ceiling (e.g., an elevated horizontal wall, or other structure) such that the first end 24 is coupled to the ceiling with the remainder of the hub 14 hanging vertically therefrom. As such, the second end 28 may be located at a vertical height less than the vertical height of the first end 24, while the central axis 20 is in a substantially plumb orientation. In alternative embodiments, the hub 14 may be coupled to other support surfaces including, but not limited to, side walls, self-standing frames, and/or the like. In such implementations, the first axis 20 may also be located in a non-plumb orientation.

In the illustrated embodiment, the hub 14 may include an interface 22 for releasably supporting one or more accessory units 26 thereto. The interface 22 may also be referred to as an accessory interface. The interface 22 may also allow one or more different types of accessory modules or units 26 (described below) to be selectively and interchangeably coupled to the hub 14. Such accessory units 26 may impart additional functionality to the ceiling fan 10, which may improve the form, function, and/or operability of the ceiling fan 10, for example, by way of causing the fan 10 to output improved lighting (e.g., via outputting light having a higher intensity, a more desirable color, and/or the like), improved airflows (e.g., via outputting heated airflows, scented airflows, and/or the like), and/or the like.

The illustrated interface 22 may include an electro-mechanical interface that provides physical support and electrical connections for the accessory unit 26. For example, the interface 22 may include, provide, and/or employ a bayonet-style coupling, a frictional-fit coupling, a spring-loaded coupling, a female/male style coupling, snaps, fasteners (e.g., set screws), and/or the like to physically secure an accessory unit 26 to the hub 14. In addition, the interface 22 may include electrically conductive contacts or wires for electrically coupling the accessory unit 26 to the hub 14. In this way, physically coupling the accessory unit 26 to the interface 22 may automatically and/or simultaneously provide an electrical connection between the accessory unit 26 and the hub 14.

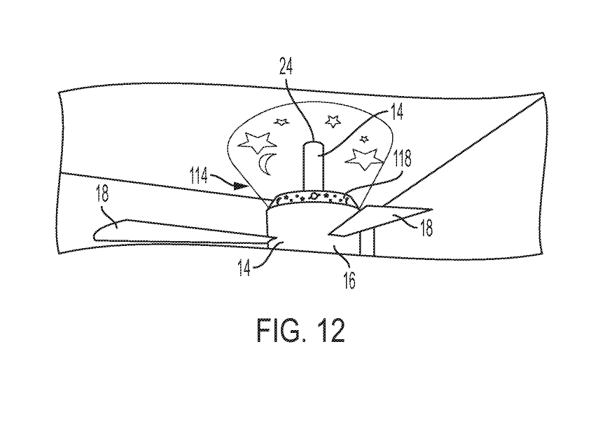

The illustrated interface 22 may be positioned proximate the second end 28 of the hub 14 such that the subframe 16 is positioned between portions of the interface 22 and the first end 24. Furthermore, the interface 22 may include a face that is oriented substantially normal to the first axis 20 in a downward orientation (i.e., facing the floor). In other embodiments, the interface 22 may be located elsewhere on the hub 14, such as proximate the first end 24 such that the interface 22 is positioned between the subframe 16 and the first end 24 (see FIG. 12). In such embodiments, the interface 22 may be oriented substantially normal to the first axis and facing upwards (i.e., facing the ceiling). Other positions and/or locations of the interface 22 respective to the hub 14 are contemplated.

As further explained below, the accessory unit 26 may be in the form of a self-contained (e.g., discrete) unit that may perform one or more tasks individually, or in conjunction with the ceiling fan 10 (see FIG. 1) to complement the ceiling fan 10. More specifically, the accessory unit 26 may include a body 32 that includes a contact surface 36 configured to releasably engage and couple with the interface 22 of the hub 14. The contact surface 36, in turn, may include at least one mechanical fastener (not shown) by which the accessory hub 26 physically couples to the body 32 to the hub 14, and/or at least one electrical contact (not shown) by which the accessory hub 26 electrically couples to the hub 14. In some embodiments, the electrical contacts of the accessory hub 26 physically contact and electrically communicate with electrical contacts of the interface 22. During use, the electrical contacts (e.g., wires, pins, terminals, plugs, ports, sockets, and/or the like) of the contact surface 36 may be configured to allow the exchange of electrical power and signals between the accessory unit 26 and the hub 14.

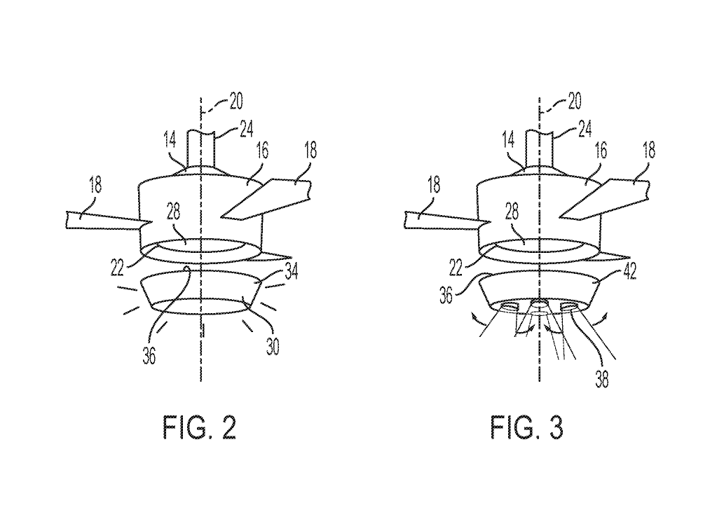

As shown in FIG. 2, one embodiment of the accessory unit 26 may include an area light 30. The area light 30 may include a light source (e.g., a bulb, a solid-state lighting source, and/or the like) housed within a cover, which may include a diffuser and/or a lens 34 to removably connect to the interface 22 of the hub 14. The light source may include, for example, one or more light emitting diodes (LEDs). In other embodiments, other light sources are contemplated, and may be used in an accessory unit described herein.

As shown in FIG. 3, another embodiment of the accessory unit 26 may include one or more adjustable spot lights 38. The spot lights 38 may be supported by a base 42 that removably connects to the interface 22 of the hub 14. In the illustrated embodiment, the spot lights 38 may be independently adjustable to direct light in different directions. Such spot lights 38 may differ in size, shape, color of light emission, intensity of light emission, and/or the like.

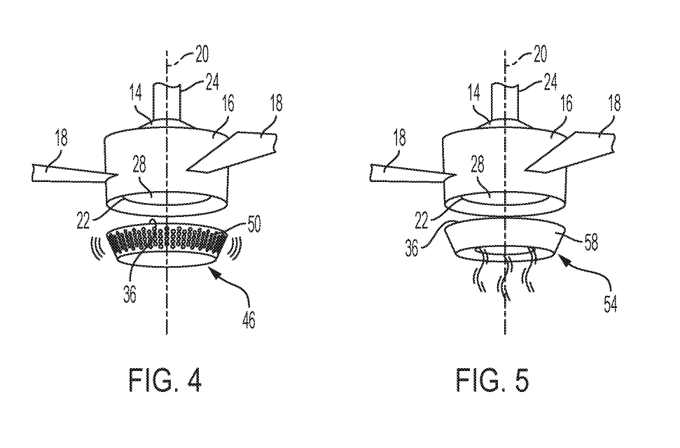

As shown in FIG. 4, another embodiment of the accessory unit 26 may include a speaker 46. The speaker 46 may include a housing 50 that removably connects (e.g., physically and electrically) to the interface 22 of the hub 14. In some embodiments, the speaker 46 may be a wireless speaker that operates via wireless communications, such as a Bluetooth® speaker, and/or the like.

As shown in FIG. 5, another embodiment of the accessory unit 26 may include a scented air distributor 54. The scented air distributor 54 may include a housing 58 that connects to the interface 22 of the hub 14 and a secondary fan positioned within the housing 58. The secondary fan may be configured to propel an airflow over a scented material (e.g., formed as a solid body, a liquid body, and/or the like). The housing 58 may define one or more outlets to direct the scented airflow into the room.

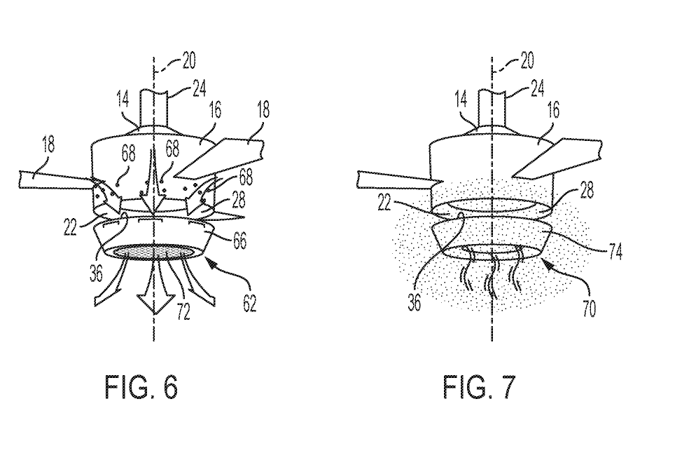

As shown in FIG. 6, another embodiment of the accessory unit 26 may include an air filter 62. The air filter 62 may include a housing 66 that connects to the interface 22 of the hub 14 and a filter member positioned within the housing 66. In some embodiments, the air filter 62 may additionally include a secondary fan positioned within the housing 66 to draw air into the housing 66, propel the air through the filter member, and direct the filtered air out of the housing 66 as indicated by the arrows in FIG. 6. Furthermore, the inlets 68 and outlet 72 may be located in any of the hub 14, subframe 16, and/or air filter 62. In embodiments where air is received in the hub or subframe 14, 16, the interface 22 may also include ducts and/or the like to guide or channel the flow of air between the hub 14, subframe 16, and/or air filter 62. In still other embodiments, the inlets 68 may be formed in the air filter 62 while the outlets 72 may be formed in the hub or subframe 14, 16.

As shown in FIG. 7, another embodiment of the accessory unit 26 may include a bug repellant diffuser 70. The bug repellant diffuser 70 may include a housing 74 that connects to the interface 22 of the hub 14 and a secondary fan positioned within the housing 74. The secondary fan may be configured to propel an airflow over a bug repellant material positioned on or within the housing 74. The housing 74 may define one or more outlets to distribute the bug repellant airflow into the room.

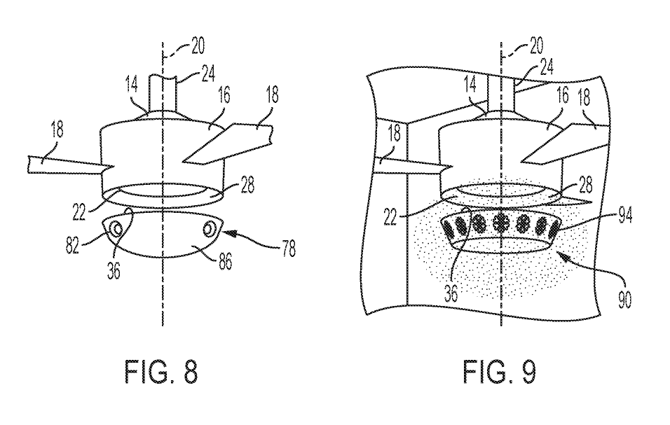

As shown in FIG. 8, another embodiment of the accessory unit 26 may include a security camera 78. In some embodiments, the security camera 78 may be a baby monitor. The security camera 78 may include one or more imaging devices 82 (e.g., optical imaging devices (e.g., cameras), thermal imaging devices, and/or the like) supported by a base 86 that connects to the interface 22 of the hub 14. In some embodiments, the security camera 78 may include a motion detector such that the imaging units 82 may activate (e.g., awaken from a sleep mode) when motion is detected.

As shown in FIG. 9, another embodiment of the accessory unit 26 may include an image diffuser 90. The image diffuser 90 may include a light source positioned within a diffuser element 94 that connects to the interface 22 of the hub 14. The diffuser element 94 can include different patterns and/or colors to change, affect, or distribute light from the light source into a room. In some embodiments, the diffuser element 94 may move relative to the light source to create moving patterns in the room. In such embodiments, the diffuser element 94 may be coupled to the subframe 16 to rotate with the fan blades 18, or the diffuser element 94 may be movable independently of the subframe 16 and the fan blades 18.

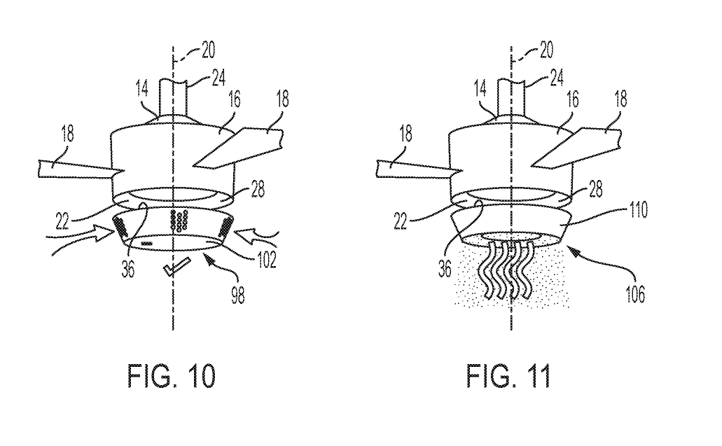

As shown in FIG. 10, another embodiment of the accessory unit 26 may include an air quality monitor 98. In some embodiments, the air quality monitor 98 may include a smoke detector, a carbon monoxide detector, and/or the like. Additionally, or alternatively, the air quality monitor may monitor toxins, chemicals, dust, carbon dioxide, humidity, and/or temperature. The air quality monitor 98 can include air quality sensors (e.g., ionization sensors, photoelectric sensors, biomimetic sensors, electrochemical sensors, opto-chemical sensors, combinations thereof, and/or the like) positioned within a housing 102 that connect to the interface 22 of the hub 14. The sensors may include wired or wireless sensors. In some embodiments, the air quality monitor 98 includes an alarm device (e.g., a light, a speaker, and/or the like) that is configured to alert a user when an air quality level satisfies a threshold. For example, where a level of smoke, CO, and/or the like satisfies a threshold, the alarm device may be activated.

As shown in FIG. 11, another embodiment of the accessory unit 26 may include a heating unit 106. The heating unit 106 includes a housing 110 that connects to the interface 22 of the hub 14, a heating element positioned within the housing 110, and a secondary fan positioned within the housing 110. The secondary fan may be configured to propel an airflow over the heating element and propel the heated airflow out of the housing 110 through one or more outlets formed in the housing 110.

As shown in FIG. 12, another embodiment of the accessory unit 26 may include an uplighting unit 114. The uplighting unit 114 may include a light source positioned within a lens or diffuser 118 that connects to the interface of the hub 14. In the illustrated embodiment, the interface is located at the upper end of the hub 14. The uplighting unit 114 is configured to direct light, such as patterned light, onto the ceiling or other surface of the room. Similar to the image diffuser 90 (FIG. 9), in some embodiments, the diffuser 118 of the uplighting unit 114 may move relative to the hub 14 to create a moving pattern on the ceiling.

Each of the above described embodiments of the accessory units 26 (e.g., including units 30, 38, 46, 54, 62, 70, 78, 90, 98, 106, and 114) may include a contact surface 36 (described above) configured to releasably engage with the interface 22 of the hub 14. As such, each accessory unit 26 (e.g., including units 30, 38, 46, 54, 62, 70, 78, 90, 98, and 106) may be interchangeably coupled respective to the hub 14. In this way, a user may customize one or more ceiling fan outputs based on selecting one or more accessory units.

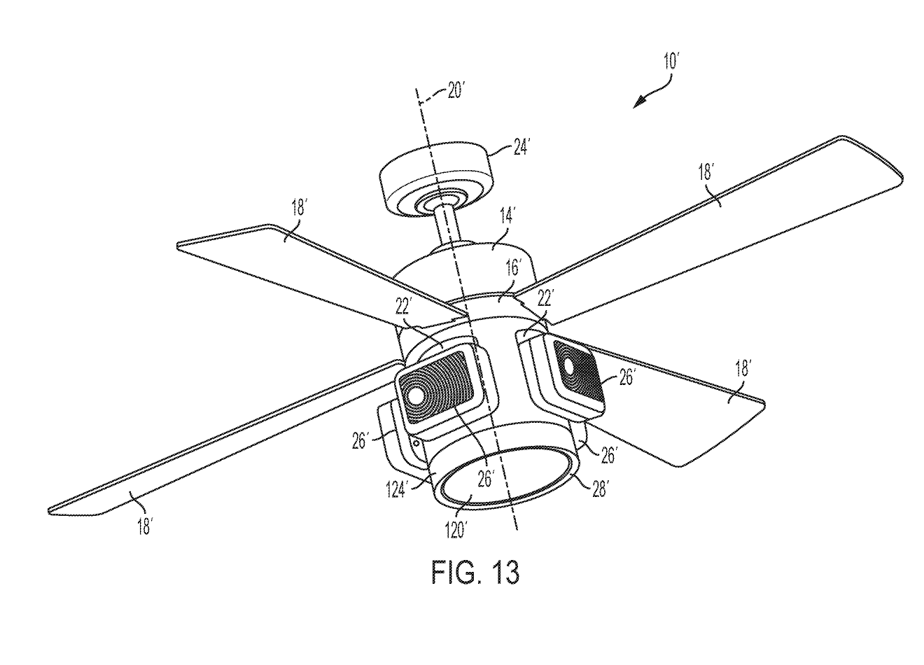

FIGS. 13-18 illustrate a further embodiment of a fan 10′. Similar to the fan 10 described above, the illustrated fan 10′ may include a ceiling fan configured to be mounted to ceiling or surface. The ceiling fan 10′ may include a hub 14′, a subframe 16′ rotatable with respect to the hub 14′ about a first or central axis 20′, and a plurality of fan blades 18′ extending radially outwardly from the subframe 16′.

The hub 14′ may include an end wall 120′ proximate the second end 28′, and a sidewall 124′ extending axially from the end wall 120′ along the periphery thereof toward the first end 24′. The sidewall 124′, in turn, may include a plurality of accessory interfaces 22′ positioned equally along the periphery thereof.

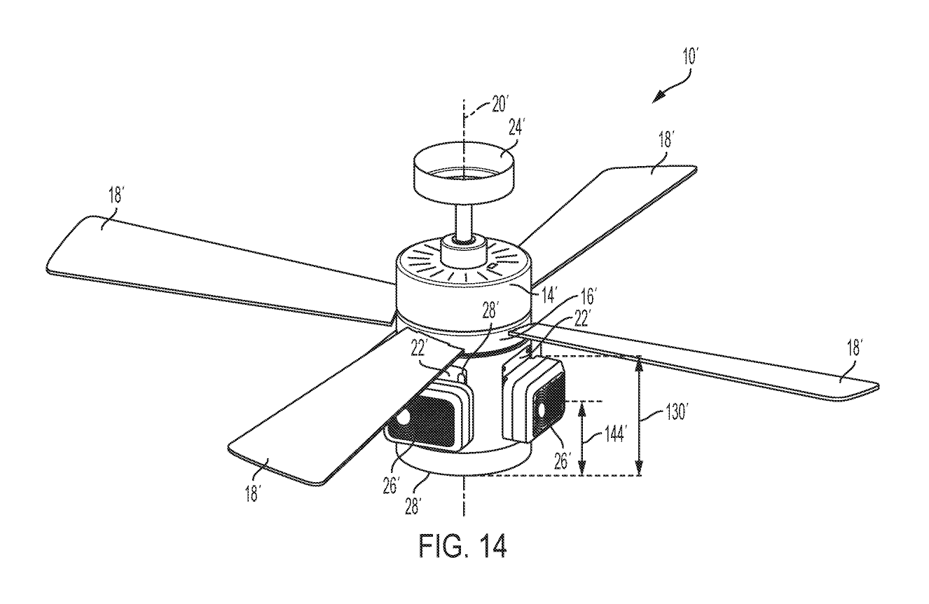

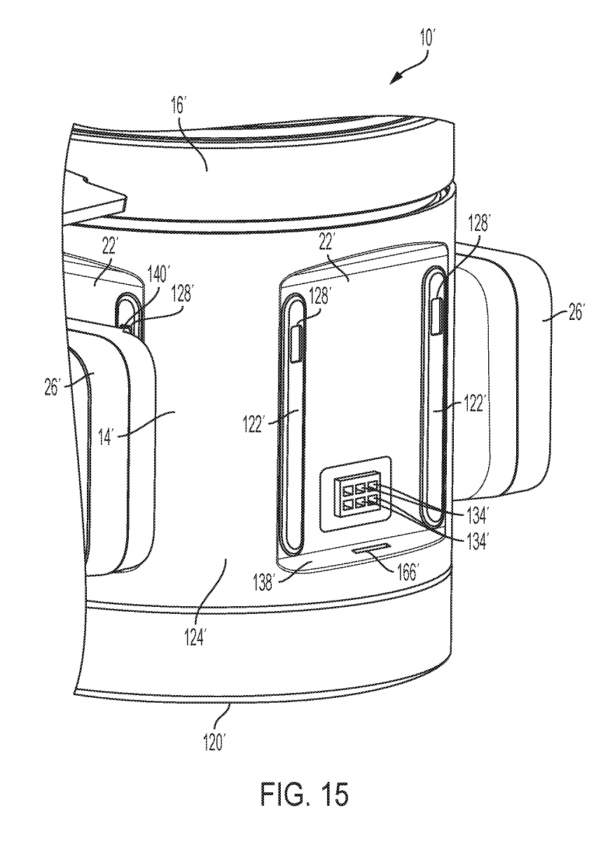

In the illustrated embodiment, the end wall 120′ may be substantially circular in shape, causing the sidewall 124′ to include a substantially cylindrical shape. In such an embodiment, each interface 22′ of the hub 14′ may include a substantially planar portion formed into the sidewall 124′. Each interface 22′ may be substantially parallel to the central axis 20′ (e.g., substantially vertical in orientation) and may include one or more first coupling members 128′ (see, e.g., FIG. 15). The coupling members 128′ may be located at a first vertical height (e.g., a first axial distance 130′ from the second end 28′; see FIG. 14) along the hub 14′. More specifically, each first coupling member 128′ may include an aperture (e.g., a slot) defined by the sidewall 124′ (see FIG. 15). Such apertures may be configured to receive and/or retain a portion of the accessory unit 26′. In the illustrated embodiment, each interface 22′ includes a pair of first coupling members 128′.

The interface 22′ may also include a set of electrical connectors 134′ (see, e.g., FIG. 15). The electrical connectors 134′ may include electro-mechanical coupling mechanisms configured to physically and/or electrically engage a corresponding set of electrical connectors 132′ in or of the accessory unit 26′ (described below). Example electrical connectors 134′ may include a socket, a port, a plug, a drive, a dongle, and/or the like, which facilitate a physical and/or electrical connection between the accessory 26′ and the interface 22′. As shown in FIG. 15, the illustrated electrical connector 134′ may be positioned vertically below the first coupling members 128′. In some embodiments, the electrical connectors 134′ may be grouped together in an electrical coupler.

The interface 22′ may also include a latch slot 166′ configured to releasably receive a corresponding latch detent 136′ of the accessory unit 26′ (described below). More specifically, the latch slot 166′ may be positioned opposite the first coupling members 128′ (e.g., proximate the bottom edge thereof). As shown in FIG. 15, the illustrated latch slot 166′ may be formed into an intermediate wall 138′ extending between and adjacent to both the interface 22′ and the sidewall 124′ and oriented substantially perpendicular to the axis 20′.

The interface 22′ may also include a pair of axially oriented ridges 122′ substantially aligned with a corresponding first coupling member 128′. Each ridge 122′ may extend radially outwardly from the interface 22′ and may be configured to engage the body 32′ of the accessory unit 26′. As shown in FIG. 15, the ridges 122′ may extend generally the entire axial height of the interface 22′. The size, shape, quantity, orientation, style, and/or placement of the various components (e.g., 122′, 128′, 134′, 138′, 166′, and/or the like) forming the interface 22′ may be increased, decreased, altered, and/or varied, in some cases.

In the illustrated embodiment, each of the interfaces 22′ may be located the same axial distance from the second end 28′ (e.g., the first axial distance 130′). In alternative embodiments, the interfaces 22′ may be positioned in alternative locations relative to each other. Still further, while each of the illustrated interfaces 22′ may be substantially parallel to the axis 20′, in alternative embodiments, the interfaces 22′ may be oriented at a different angle relative to the axis 20′ as necessary to properly support the desired size and/or quantity of accessory units 26′.

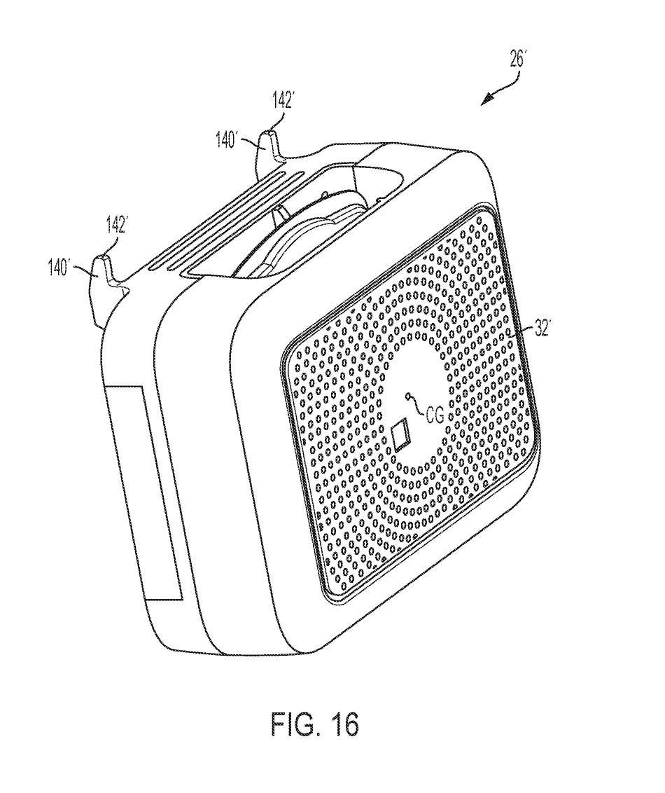

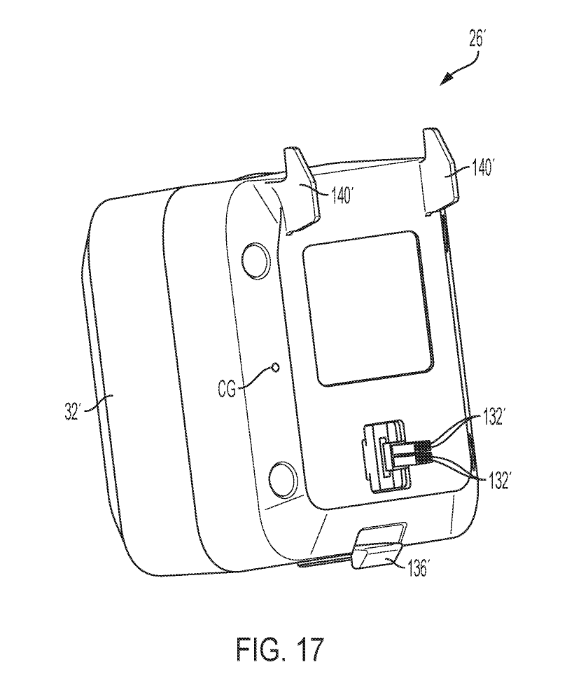

As shown in FIGS. 16 and 17, the accessory unit 26′ of the ceiling fan 10′ may include a body 32′. The accessory unit 26′ may define a center of gravity CG that is located at a second vertical height (e.g., a second axial 144′ distance from the second end 28′) when the accessory unit 26′ is coupled to the hub 14′. The accessory unit 26′ may also include one or more second coupling members 140′ configured to releasably engage a corresponding first coupling member 128′ and support the accessory unit 26′ relative to the hub 14′. The illustrated second coupling members 140′ may be located at the first vertical height (e.g., the first axial distance 130′ from the second end 28′) when the accessory unit 26′ is coupled to the hub 14′ that is greater than the second vertical height (e.g., the first axial distance 130′ is greater than the second axial distance 144′).

In the illustrated embodiment, each second coupling member 140′ may include an arm or hook. The hook may be an outward facing hook (e.g., having a distal end 142′ positioned outwardly away from the body 32′). The hook may be sized and shaped to be at least partially received within the corresponding slot of the first coupling member 128′. In other embodiments, the first coupling members 128′ may include hooks, and the second coupling members 140′ may include slots. Other types of coupling members (e.g., 128′ and 140′) are contemplated. When the accessory unit 26′ is attached to the interface 22′, the center of gravity CG of the accessory unit 26′ may be positioned below the coupling members 128′, 140′.

The accessory unit 26′ may also include one or more electrical connectors 132′ (see, e.g., FIG. 17). The electrical connectors 132′ may be configured to contact and/or engage the connectors 134′ of the interface 22′. In the illustrated embodiment, the electrical connectors 132′ on the accessory unit 26′ may include male pins or plugs configured to fit into female receptacles of the electrical connectors 134′ on the interface 22′. In other embodiments, the electrical connectors 132′ of the accessory unit 26′ may include female receptacles, and the electrical connectors 134′ of the interface 22′ may include male pins or plugs.

The accessory unit 26′ may also include a latch 136′. The latch 136′ is supported on a lower surface of the body 32′. The latch 26′ may be configured to be at least partially received within and engage the corresponding latch slot 166′ of the interface 22′. Once inserted, the latch 136′ may be configured to retain the accessory unit 26′ relative to the hub 14′ so that the two are relatively fixed. To remove the accessory unit 26′ from the hub 14′, the latch 136′ may be disengaged from the corresponding latch slot 166′ of the interface 22′. In the illustrated embodiment, the latch 26′ may include a manual actuator (e.g., a push-button actuator, a sliding actuator, and/or the like) that may be actuated (e.g., depressed, slid, and/or the like) by a user to move the latch 26. In other embodiments, the latch 26′ may include other types of actuators, such as a dial, switch, rotatable fastener, and/or the like.

While the illustrated accessory unit 26′ is shown as a speaker unit, the accessory unit 26′ may include, and is not limited to, any of the accessory units described above with respect to FIGS. 1-12. Furthermore, while each accessory unit 26′ may be substantially similar in the illustrated embodiment, in alternative implementations, various combinations of different accessory units 26′ may be used. Still further, not all interfaces 22′ of the hub 14′ needs to be filled at any one time. That is, some of the interfaces 22′ may be coupled to an accessory unit 26′, while other interfaces 22′ may be devoid of an accessory unit 26′.

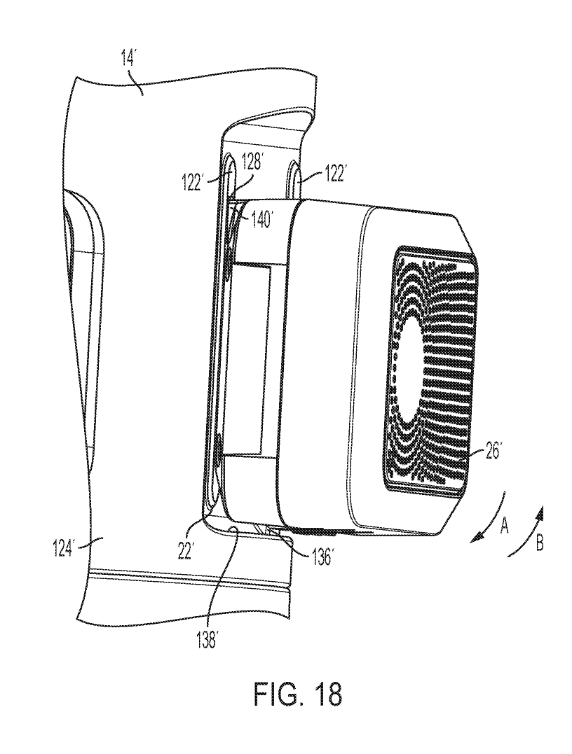

Referring to FIG. 18, to couple the accessory unit 26′ so the interface 22′ of the ceiling fan 10′, the distal ends 142′ of the second coupling members 140′ may be inserted into a corresponding slot of the first coupling members 128′. With the ends 142′ inserted, the accessory unit 26′ may be moved about the second coupling members 140′ in a first direction A (see FIG. 18) until the electrical connectors 132′ of the accessory unit 26′ engage with and come into electrical contact with the connectors 134′ of the interface 22′. The accessory unit 26′ may be positioned such that the latch 136′ is at least partially positioned within the corresponding latch slot 166′ of the interface 22′. When the latch detent 136′ is in place, the accessory unit 26′ may be fixed relative to the hub 14′ of the fan 10′ and may be in electrical communication therewith.

To remove an accessory unit 26′, the user may engage the latch 136′ to move the latch 136′ out of the latch slot 166′. When the latch 136′ is out of the corresponding slot 166′, the unit 26′ may be moved relative to the interface 22′ in a second direction B, opposite the direction A, causing the electrical connectors 132′, 134′ to disengage. The second coupling members 140′ may be removed from the slots of the first coupling members 128′ to disengage the accessory unit 26′ from the interface 22′.

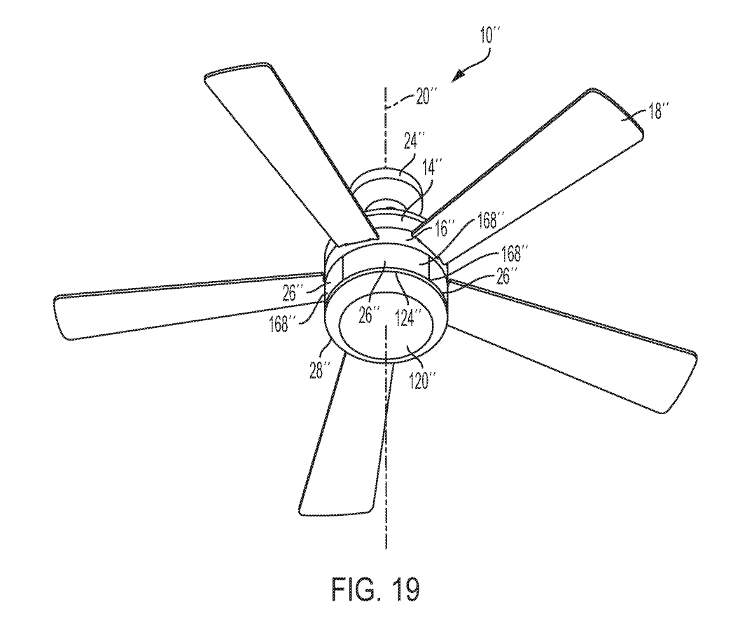

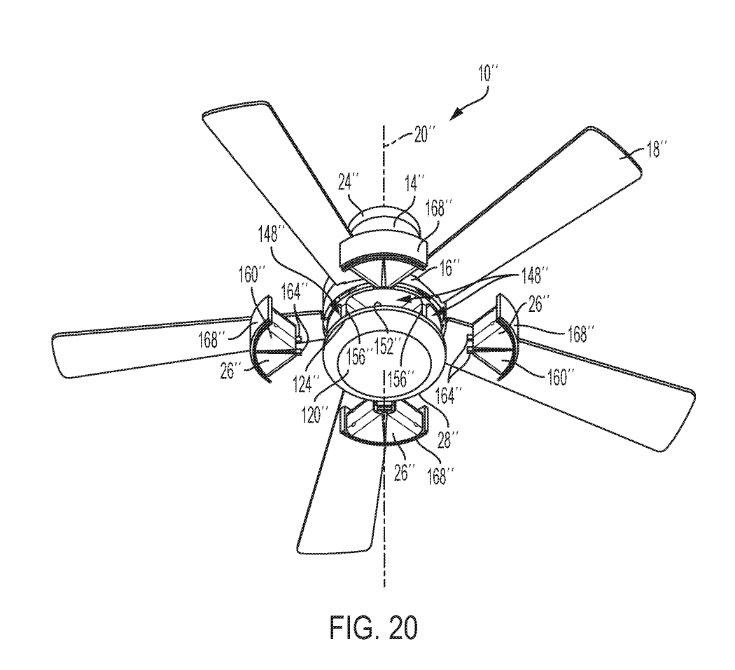

FIGS. 19 and 20 illustrate another fan 10″. Similar to the fan 10 described above, the illustrated fan 10,′ may include a ceiling fan configured to be mounted to a ceiling or surface. The ceiling fan 10″ may include a hub 14″, a subframe 16″ rotatable with respect to the hub 14″ about a first or central axis 20″, and a plurality of fan blades 18″ extending radially outwardly from the subframe 16″.

The hub 14″ may include an end wall 120″ proximate the second end 28″, and a sidewall 124″ extending axially from the end wall 120″ toward the first end 24″. The hub 14″ may also define a plurality of recesses, or pockets 148″ (see, e.g., FIG. 20). A pocket 148″ may be configured to receive at least a portion of a corresponding accessory unit 26″ therein. The pockets 148″ may also be open through the sidewall 124″ of the hub 14″. For example, the pockets 148″ may define a separate opening 152″, and the pockets 148″ may extend radially inwardly therefrom. The size and shape of the pockets 148″ may allow an accessory unit 26″ to be coupled to the hub 14″ without expanding the overall footprint of the hub 14″ itself. The size, shape, and/or quantity of pockets 148″ may differ from that shown in FIGS. 19-20. Other sizes, shapes, and/or quantities of pockets 148″ are contemplated.

The pockets 148″ and respective openings 152″ may be equally or non-equally spaced around the periphery of the hub 14″. One pocket 148″ and respective opening 152″ may be provided per fan 10″, or more than one pocket 1418″ and respective opening 152″ may be provided per fan 10″. The number of pockets 148″ and respective openings 152″ may be provided as an even number or an odd number. In the illustrated embodiment, the hub 14″ may define four openings 152″ each extending substantially 90 degrees about the central axis 20″. In other embodiment, the hub 14″ may define fewer or more openings 152″, and/or the openings 152″ may extend a greater or lesser or angle about the central axis 20″. The pockets 148″ may be separated by dividing walls 156″ that extend substantially radial relative to the axis 20″. Together, the radial walls 156″ and the openings 152″ may define the pocket 148″, which may be wedge-shaped. In other embodiments, the pockets 148″ may take other forms, such as rectangular, hemispherical, half-cylindrical, and/or the like.

The pockets 148″ may include an accessory interface 22″ defined therein. The accessory interfaces 22″, as described above, may be configured to provide physical support and electrical connections for the accessory units 26″ received in and/or positioned within the respective pockets 148″.

The accessory units 26″ of the ceiling fan 10″ may substantially correspond to the overall size and shape of the corresponding pockets 148″. Each accessory unit 26″ may include a body 160″. The body 160″ may be wedge-shaped to match the shape of the pocket 148″. Alternatively, the body 160″ may be other shapes, depending on the shape of the pocket 148″. Each accessory unit 26″ may also include one or more connectors 164″ configured to mechanically and/or electrically engage with the corresponding interface 22″.

The body 160″ of each accessory unit 26″ may include an exterior wall 168″. The exterior wall 168″ may be configured to be located proximate the opening 152″ of the corresponding pocket 148″ when the accessory unit 26″ is positioned therein. In some embodiments, the exterior wall 168″ may be sized and shaped such that none of the body 160′ of the accessory units 26″ extends beyond the exterior of the hub 14″. In other words, the exterior wall 168″ may be flush with an outer surface of to the hub 14″ and may generally follow the same contour as the outer surface of the hub 14″. In such embodiments, the body 160′ may not increase the overall footprint of the hub 14″. In other embodiments, the exterior wall 168″ may substantially correspond to the shape of the sidewall 124″ of the hub 14″.

While the accessory units 26″ of the ceiling fan 10″ are shown being substantially similar, different styles and types of accessory units 26″ may be installed in the fan 10″. The accessory units 26″ may be any of the accessory units described above with respect to FIGS. 1-12

Although the illustrated accessories are described independently, in some embodiments, two or more of the accessories may be combined into a single accessory. For example, an accessory could include a combination light, security camera, and heating unit. Additionally, in further embodiments, the accessories may be integrated into the ceiling fan, rather than removable from the ceiling fan.

Various features and advantages are set forth in the following claims.

1. A fan comprising:
a hub having:
a first end,
a second end opposite the first end,
a central axis extending through the first end and the second end, and
an accessory interface disposed proximate to the first end or the second end;
a subframe disposed proximate to the hub,
the subframe being rotatable with respect to the hub about the central axis;
a plurality of fan blades extending outwardly from the subframe; and
an accessory unit,
the accessory unit being removably coupled to the accessory interface of the hub.

2. The fan of claim 1, wherein the accessory interface includes an electro-mechanical interface.

3. The fan of claim 1, wherein the accessory unit is selected from the group consisting of:
an area light,
a spot light,
a speaker,
a scented air distributor,
an air filter,
a bug repellant diffuser,
a security camera,
an image diffuser,
an air quality monitor, and
a heating unit.

4. The fan of claim 1, wherein:
the fan is a ceiling fan, and
the first end of the hub is configured to be coupled to an overhead support structure.

5. The fan of claim 4, wherein the accessory interface is positioned at the second end of the hub.

6. The fan of claim 1, wherein the accessory interface is oriented perpendicular to the central axis.

7. The fan of claim 1, wherein the accessory interface is positioned between the subframe and the second end of the hub.

8. The fan of claim 1, wherein the accessory interface is oriented parallel to the central axis.

9. The fan of claim 1, wherein the accessory unit is removably coupled to the accessory interface via a coupling mechanism.

10. The fan of claim 9, wherein the coupling mechanism includes:
an aperture defined by one of the accessory interface and the accessory unit, and
a hook coupled to another of the accessory interface and the accessory unit, wherein the hook is receivable in the aperture.

11. The fan of claim 10, wherein:
the coupling mechanism further includes a latch supported by one of the accessory interface and the accessory unit, and
the latch releasably engages another of the accessory interface and the accessory unit.

12. The fan of claim 1, wherein:
the hub includes an outer wall,
the accessory interface includes a pocket formed in the hub and open to the outer wall, and
the accessory unit is at least partially received in the pocket.

13. The fan of claim 12, wherein an outer surface of the accessory unit is substantially flush with the outer wall of the hub.

14. The fan of claim 12, wherein:
the pocket is generally wedge-shaped, and
the accessory unit is generally wedge-shaped.

15. The fan of claim 1, wherein:
the accessory unit is one accessory unit of a plurality of accessory units, and
each accessory unit of the plurality of accessory units is configured to be removably coupled to the accessory interface of the hub.

16. A fan comprising:
a hub including an accessory interface having an electro-mechanical coupling mechanism;
a subframe rotatable with respect to the hub;
a plurality of fan blades extending outwardly from the subframe;
a first accessory unit configured to removably couple to the accessory interface of the hub; and
a second accessory unit configured to removably couple to the accessory interface of hub.

17. The fan of claim 16, wherein the second accessory unit is coupled to another accessory interface of the hub while the first accessory unit is coupled to the accessory interface.

18. The fan of claim 16, wherein the first accessory unit and the second accessory unit are alternately coupled to the accessory interface of the hub.

19. The fan of claim 16, wherein the first accessory unit or the second accessory unit is selected from the group consisting of:
an area light,
a spot light,
a speaker,
a scented air distributor,
an air filter,
a bug repellant diffuser,
a security camera,
an image diffuser,
an air quality monitor, and
a heating unit, and.

20. A fan comprising:
a hub including:
a first accessory interface, and
a second accessory interface;
a subframe rotatable with respect to the hub;
a plurality of fan blades extending outwardly from the subframe;
a first accessory unit physically and electrically coupled to the first accessory interface,
the first accessory unit being configured to perform a first task; and
a second accessory unit physically and electrically coupled to the second accessory interface,
the second accessory unit being configured to perform a second task.

21. The fan of claim 20, wherein the first task or the second task is selected from the group consisting of:
emitting light,
emitting an audio signal,
dispensing a scent,
dispensing a bug replant,
filtering air,
monitoring an air quality,
heating air, and
obtaining an image.
